(19) United States
(12) Patent Application Publication
(10) Pub. No.: US 2025/0065754 A1
(43) Pub. Date: Feb. 27, 2025

(54) SYSTEMS AND METHODS FOR IMPROVING EFFICIENCY OF ELECTRIC VEHICLE CHARGING STATIONS

(71) Applicant: Adeia Guides Inc., San Jose, CA (US)

(72) Inventors: Tao Chen, Palo Alto, CA (US); Toshiro Ozawa, Irvine, CA (US); Ning Xu, Irvine, CA (US)

(21) Appl. No.: 18/236,149

(22) Filed: Aug. 21, 2023

(51) Int. Cl. B60L 53/65; B60L 53/30; B60L 53/62

(52) U.S. Cl. CPC B60L 53/65; B60L 53/305; B60L 53/62

(57) ABSTRACT

Systems and methods are provided herein for improving efficiency of electric vehicle charging stations by allowing multiple charging connectors from each charging port at a station, so that the connectors can be plugged into multiple vehicles at the same time, establishing a queue based on order of arrival and other factors, and automatically switching active charging among the connectors. Specifically, the vehicle charging station identifies a plurality of vehicles simultaneously electrically connected to a plurality of charging cables, then identifies an order of connection of the plurality of vehicles to the plurality of charging cables, and based on the order of connection, selects a subset of the plurality of vehicles to be charged, then configures the switch system to enable the at least one power generator to charge the subset of the plurality of vehicles.

### BACKGROUND

The present disclosure relates to techniques for improving the efficiency of electric vehicle charging stations.

### SUMMARY

It takes more time to charge an electric vehicle than it does to fill a gasoline-powered vehicle with fuel. Home charging systems can charge vehicles while vehicles are at home, but the time it takes to charge outside of the home, for example, during a road trip, at an office or at a school, can depend on a plethora of factors. In one approach, the number of charging cables at a charging station, e.g., three cables, is equal to the number of vehicles that the charging station is capable of charging simultaneously, e.g., three vehicles. If a charging cable is available at a charging station, the vehicle can be plugged in and left to charge, for example, while a driver is away, and the driver can come back to a charged vehicle without any extra effort.

This approach is deficient because if all cables are occupied when a vehicle arrives at a charging station, the vehicle will have to wait without being charged until another vehicle leaves. Further, when a cable becomes available, the vehicle has to be moved into the spot and manually plugged in, e.g., by the driver. If the driver happens to be away from the vehicle, there will be a delay between when a charging slot and cable open up and when the vehicle is plugged in. This is inefficient, because the system is not charging a vehicle in a time that it could have been, leaving both the vehicle and the system unnecessarily idle. Over the course of a day, such delays can degrade the average efficiency of a charging station significantly, as a lot of time is spent idling while waiting for a vehicle to be plugged in.

This approach is also inefficient and frustrating for drivers of electric vehicles. If a charging cable is not available when a driver arrives at a station and the driver has to go into work or school immediately, they will either have to come back to check repeatedly for an available charger and repark their vehicle, or they will have to accept that their vehicle isn't going to get charged. Further, if the driver is on a road trip, the driver cannot go and rest while they wait for an available cable; they must stay in their vehicle and monitor the charging cables. Additionally, delays may also be created in the process of unplugging fully charged vehicles. While drivers may have the option to monitor the charging status of their plugged-in vehicles, they may be too busy to immediately move the vehicle when it is done charging. This may then leave other EV drivers waiting to plug in, causing frustration, further delays, and generally inefficient use of charging stations.

In some approaches, the number of charging cables at a charging station, e.g., two cables, is greater than the number of vehicles that the charging station is capable of charging simultaneously, e.g., one vehicle. In one approach, one of the cables is the priority cable, and the other is the secondary cable, meaning that whatever vehicle is plugged into the priority cable will always be fully charged before the vehicle plugged into the secondary cable will begin to charge, even if the secondary cable was plugged in first. In this example, the second vehicle could be plugged in right away, and charging would start when the first vehicle is finished. However, if the first vehicle was unplugged and a third vehicle was then plugged into the prioritized cable, the secondary cable would immediately stop providing power, and would not resume providing power until the prioritized cable was finished charging the third vehicle. The second vehicle will not even begin to charge until the prioritized cable completely finishes charging the third vehicle. This approach is deficient because the vehicle plugged into the secondary cable may never even be charged if different vehicles continue to be plugged into the primary cable.

To overcome these problems, systems and methods are provided herein for improving efficiency of electric vehicle charging stations by allowing multiple charging connectors from each charging port at a station, so that the connectors can be plugged into multiple vehicles at the same time, establishing a queue based on order of arrival and other factors, and automatically switching active charging among the connectors. In this approach, even when the maximum number of vehicles that can be charged at once are already plugged in, a later-arriving vehicle can electrically connect to a charging cable even if it does not start charging right away. Also, a fully charged vehicle does not have to be moved immediately for other waiting vehicles to promptly begin charging. This approach improves charging station efficiency by significantly reducing the time a vehicle is waiting to connect to a vehicle charging station and allows for a vehicle to not need to be immediately moved once it is fully charged. Further, establishing a queue based on order of arrival ensures that each car will be charged in an efficient amount of time, preventing scenarios where some vehicles can be left uncharged even when plugged in for an extended period of time.

In some embodiments, a vehicle charging station has at least one power generator and a plurality of charging cables electrically connected to the one or more power generators by a switch system. In this embodiment, each respective charging cable of the plurality of charging cables is electrically connected to a respective vehicle of a plurality of vehicles, and only a subset of the plurality of charging cables is capable of providing power to vehicles simultaneously. In some embodiments, the vehicle charging station identifies a plurality of vehicles simultaneously electrically connected to a plurality of charging cables. In some embodiments, the vehicle charging station identifies an order of connection of the plurality of vehicles to the plurality of charging cables, and based on the order of connection, selects a subset of the plurality of vehicles to be charged. In some embodiments, the number of vehicles in the subset of the plurality of vehicles to be charged is less than or equal to the number of charging cables in the subset of the charging cables capable of providing power to the subset of the plurality of vehicles. In some embodiments, the vehicle charging station configures the switch system to enable the at least one power generator to charge the subset of the plurality of vehicles. In some embodiments, the vehicle charging station configures the switch system so that the one or more power generators do not charge vehicles connected to a charging cable that are not in the subset of vehicles to be charged.

Such aspects of the improved charging station allow more vehicles to be plugged into the charging station than the charging station is capable of servicing at once, so that fewer vehicles have to wait until charging cables become available and fully powered vehicles do not have to be unplugged immediately, while the charging station charges the vehicles in a queue based on when they plugged in. Further, in this approach, no cable takes automatic priority over any other cable; cables are chosen to provide power based on when each vehicle plugs into the charging station.

In some embodiments, the vehicle charging station chooses the vehicles to be in the subset of vehicles to be charged not only based on which vehicles were the first to electrically connect to charging cables, but also the charge level of each vehicle, charging settings of each vehicle, vehicle charging user account status, price paid by vehicle charging user account for charging, time specified by the vehicle charging user account that the vehicle will be connected to a charging cable, number of charging cables currently providing power to vehicles, and/or charging capability of the system.

Such aspects of the improved charging station allow the vehicle charging station to dynamically create the most efficient charging queue. In such embodiments, the charging station does not just charge a set number of vehicles at a time and add the next vehicle when all the originally charging vehicles are fully powered. Rather, the charging station weighs a variety of factors to build a charging queue that will allow all vehicles to charge as closely as possible to their desired battery level in the amount of time that the vehicles will be at the charging station.

In some embodiments, the charging station is configured to receive data from user devices associated with vehicle charging user accounts of vehicles connected to charging cables at the charging station. In some embodiments, the user interface, e.g., an app, has a user-selectable option to modify the charging settings of the vehicle via a user selection of a battery percentage at which to stop or slow charging of the vehicle.

In some embodiments, the charging station stops or slows charging of each vehicle when it reaches the battery level specified in the charging settings of each vehicle charging user account of each vehicle and proceeds to begin charging a different vehicle. For example, if the charging station receives, from a user device associated with a vehicle, via a user interface (e.g., an app), a user selection to change the charging settings of a vehicle to stop or slow charging at 80%, the charging station stops or slow charging of the vehicle when the vehicle's battery percentage reaches 80% and begins charging the next vehicle in the queue.

Such aspects of the improved charging station allow for the batteries of vehicles to be protected, as it promotes battery health and longevity to stop providing power to fully charged vehicles, as well as allowing for better general use of the charging station. A charging station can allocate its power more efficiently when it is not charging every vehicle to 100%. For example, if four vehicles are charged to 80% battery level, all four vehicles will be able to be driven towards their next destinations with a substantial amount of charge, whereas if three of those vehicles have a 100% charge while the fourth has only 20%, the fourth car will have significantly less mileage.

In some embodiments, the user interface, e.g., a charging app, on a user device associated with a vehicle charging user account of a vehicle has an indication of how many cars will begin charging before that vehicle begins charging. In some embodiments, the user interface has an indication of how many minutes it will take before charging of the vehicle is complete. In some embodiments, the vehicle charging station chooses a vehicle to be charged prior to an earlier-arriving vehicle based on the charging setting of the vehicle being at a certain battery level.

For example, a charging app on a phone logged into a vehicle charging user account associated with a plugged-in vehicle displays an indication that two other vehicles will begin charging before the vehicle. In this example, the charging app also displays an indication that charging of the vehicle will be complete in ninety minutes. In this example, the charging station receives, from a user device associated with a vehicle, via a user interface (e.g., an app), a user selection to change the charging settings of a vehicle to stop or slow charging at 90%. In this example, in response to receiving the user selection, the charging station moves the vehicle up in the charging queue, and as a result, the app now displays an indication that one other vehicle will begin charging before the vehicle, and an indication that charging of the vehicle will be complete in 45 minutes.

Such aspects of the improved charging station reward the vehicles with lower stop charge battery percentages by allowing them to skip the line. Incentivizing low stop charge battery percentages optimizes station efficiency, while also continuing to provide a satisfactory charge to the other vehicles, whose drivers may have chosen to charge to a higher battery level.

The methods and systems described herein can be applied to other devices; charging stations for electric vehicles can charge more than just vehicles, for example, large appliances and other devices. In one example, a charging station in a workshop has the capability to charge two tools at once, but there are three charging cables attached to the charging station. Three tools connect to the charging cables, for example, a power drill, a circular saw, and a palm sander. In some embodiments, the charging station identifies that the power drill connected first, then the saw, then the sander. In some embodiments, the charging station selects the power drill and the circular saw for initial charging, and then configures the switch system to charge the power drill and the circular saw. In this embodiment, once one of the power drill or the circular saw finishes charging, the charging station configures the switch system to begin charging the palm sander. In some embodiments, the charging settings of the palm sander specify that the palm sander only needs to be charged to, e.g., 70%. In this embodiment, the charging station selects the power drill and the palm sander for initial charging, even though the circular saw connected before the palm sander. In this embodiment, once the palm sander is charged to 70%, the vehicle charging station configures the switch system to begin charging the circular saw.

### BRIEF DESCRIPTION OF THE DRAWINGS

The present disclosure, in accordance with one or more various embodiments, is described with reference to the following figures. The drawings are provided for purposes of illustration only and merely depict typical or example embodiments. These drawings are provided to facilitate an understanding of the concepts disclosed herein and do not limit the breadth, scope, or applicability of these concepts. It should be noted that for clarity and ease of illustration these drawings are not necessarily made to scale.

FIG. 1 is an illustrative example of a system for improving efficiency of electric vehicle charging stations, in accordance with some embodiments of the present disclosure;

FIG. 2 is a system diagram of a switch system for power flow from power banks to charging cables, in accordance with some embodiments of the present disclosure;

FIG. 3 is an illustrative example of resource allocation of a 300-kilowatt (kW) charger to five vehicles, in accordance with some embodiments of the present disclosure;

FIG. 4 is an illustrative example of time-sharing chargers dynamically switching resources, in accordance with some embodiments of the present disclosure;

FIG. 5 shows illustrative devices, systems, servers, and related hardware for improving efficiency of electric vehicle charging stations, in accordance with some embodiments of the present disclosure;

FIG. 6 is an illustrative example of a user interface system for improving efficiency of electric vehicle charging stations, in accordance with some embodiments of the present disclosure;

FIG. 7 is an illustrative example of a user interface system for improving efficiency of electric vehicle charging stations, in accordance with some embodiments of the present disclosure;

FIG. 8 shows a flowchart of an illustrative process for improving efficiency of electric vehicle charging stations, in accordance with some embodiments of the present disclosure;

FIG. 9 shows a flowchart of an illustrative process for improving efficiency of electric vehicle charging stations, in accordance with some embodiments of the present disclosure;

FIG. 10 shows a flowchart of an illustrative process for improving efficiency of electric vehicle charging stations, in accordance with some embodiments of the present disclosure.

### DETAILED DESCRIPTION OF EMBODIMENTS OF THE DISCLOSURE

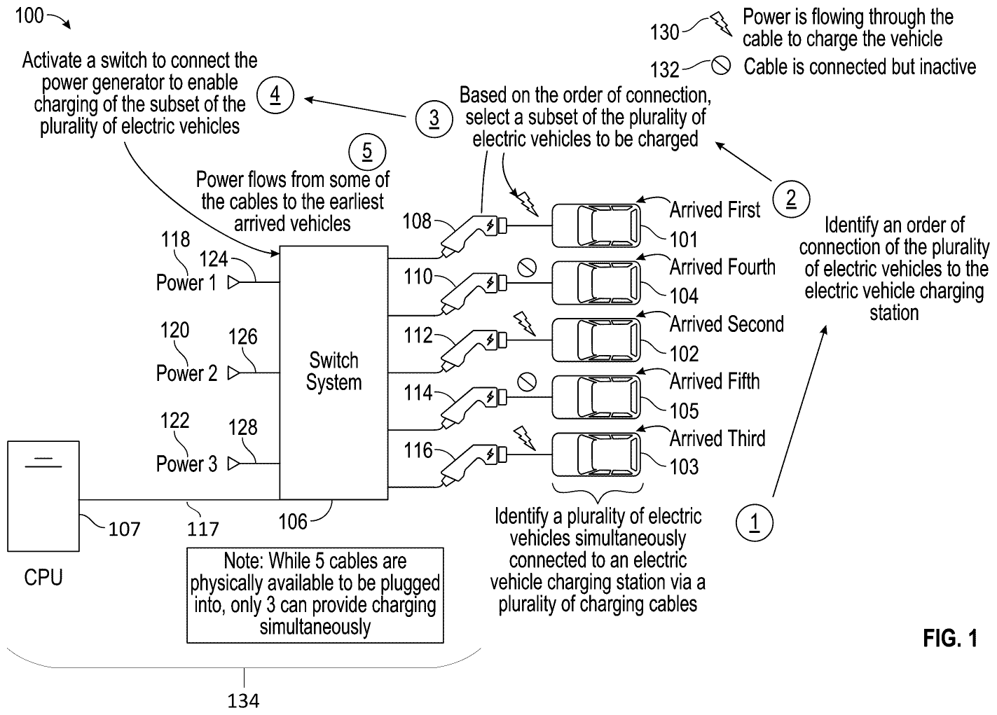

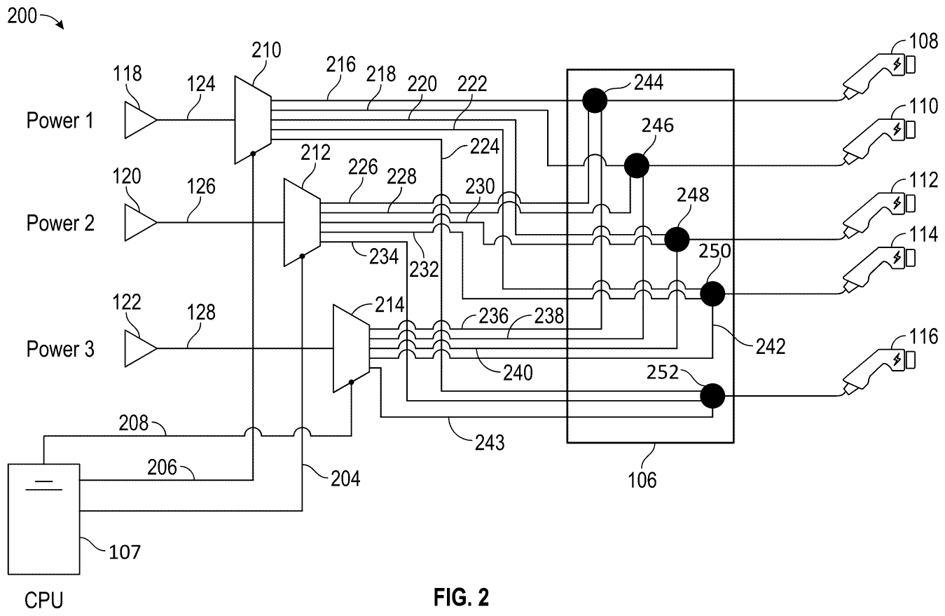

FIG. 1 shows an illustrative example of a system 100 for improving efficiency of electric vehicle charging stations, in accordance with some embodiments of the present disclosure. In some embodiments, system 100 includes vehicles 101-105, and electric vehicle charging station 134, which includes switch system 106, charging station central processing unit (CPU) 107, charging cables 108-116, CPU to switch system connector 117, power generators 118-122, and power generator to switch system connector cables 124-128. In some embodiments, vehicles 101-105 include cars, trucks, buses, drivable construction equipment, vans, electric bikes, or any other suitable chargeable machinery with a battery. System 100 may include additional servers, devices and/or networks. In one approach, within electric vehicle charging station 134, charging cables 108-116 are electrically connected to power generators 118-122 by switch system 106, as described further below with reference to FIG. 2. In some embodiments, electrical connection is a conductive path, possibly interrupted by a switch, that may allow flow of electrons, e.g., alternating current and direct current flow. In some embodiments, within electric vehicle charging station 134, charging station CPU 107 is connected to switch system 106 via CPU to switch system connector 117, power generator 1 118 is connected to switch system 106 via power generator to switch system connector cable 124, power generator 2 120 is connected to switch system 106 via power generator to switch system connector cable 126, and power generator 3 122 is connected to switch system 106 via power generator to switch system connector cable 128.

In some examples, the steps outlined within system 100 are performed by a central processing unit (CPU), for example, charging station CPU 107. For example, a non-transitory memory of charging station CPU 107 may store instructions that, when executed by processors of those devices, cause execution of the steps outlined within system 100.

In some embodiments, at step 1, charging station CPU 107 identifies vehicles 101-105 simultaneously connected to switch system 106 via charging cables 108-116. In some embodiments, vehicle 101 is connected to electric vehicle charging station 134 via charging cable 108, vehicle 102 is connected to electric vehicle charging station 134 via charging cable 112, vehicle 103 is connected to electric vehicle charging station 134 via charging cable 116, vehicle 104 is connected to electric vehicle charging station 134 via charging cable 110, and vehicle 105 is connected to electric vehicle charging station 134 via charging cable 114.

In some embodiments, at step 2, charging station CPU 107 identifies the order vehicles 101-105 connected to electric vehicle charging station 134 via charging cables 108-116. In some approaches, charging station CPU 107 identifies that vehicle 101 connected to electric vehicle charging station 134 first, vehicle 102 connected to electric vehicle charging station 134 second, vehicle 103 connected to electric vehicle charging station 134 third, vehicle 104 connected to electric vehicle charging station 134 fourth, and vehicle 105 connected to electric vehicle charging station 134 fifth.

In some embodiments, at step 3, charging station CPU 107 selects a subset of vehicles 101-105 for electric vehicle charging station 134 to charge, based on the order that they connected to electric vehicle charging station 134 (determined at step 2). In one example, because there are three power generators, power generator 1 118, power generator 2 120, and power generator 3 122, electric vehicle charging station 134 is able to charge three vehicles simultaneously, although five vehicles are able to simultaneously connect to electric vehicle charging station 134 via charging cables 108-116. In some embodiments, charging station CPU 107 selects vehicle 101, vehicle 102, and vehicle 103 to be charged by electric vehicle charging station 134 because vehicle 101 plugged in first, vehicle 102 plugged in second, and vehicle 103 plugged in third. In this example, lightning bolt indicators 130 are depicted above charging cable 108, charging cable 112, and charging cable 116 because charging station CPU 107 has chosen the connected vehicles, vehicle 101, vehicle 102, and vehicle 103, to be in the subset of vehicles to be charged. In this example, not charging indicators 132 are depicted above charging cable 110 and charging cable 114 because charging station CPU 107 has not chosen the connected vehicles, vehicle 104 and vehicle 105, to be in the subset of vehicles to be charged.

In some embodiments, at step 4, charging station CPU 107 activates switch system 106 to connect power generator 1 118 to charging cable 108, power generator 2 120 to charging cable 112, and power generator 3 122 to charging cable 116 to enable charging of vehicle 101, vehicle 102, and vehicle 103, respectively, as described further below with reference to FIG. 2.

In some embodiments, at step 5, power flows from some of the charging cables, charging cable 108, charging cable 112, and charging cable 116, to the earliest-plugged-in vehicles, vehicle 101, vehicle 102, and vehicle 103. In this example, lightning bolt indicators 130 are depicted above charging cable 108, charging cable 112, and charging cable 116 to indicate that power is flowing through the cable to charge the connected vehicles, vehicle 101, vehicle 102, and vehicle 103. In this example, not charging indicators 132 are depicted above charging cable 110 and charging cable 114 to indicate that the cable is connected to a vehicle, but it is inactive, i.e., power is not flowing through the cable to charge the connected vehicle.

The improvement aspects outlined in system 100 may be combined in any suitable combination, taken in part, or as a whole.

FIG. 2 shows a system diagram of a switch system for power flow from power banks to charging cables, in accordance with some embodiments of the present disclosure. In some embodiments, system 200 is electric vehicle charging station 134 of FIG. 1, which includes charging station CPU 107, charging cables 108-116, power generators 118-122, power generator to switch system connector cables 124-128, CPU to switch system demultiplexer connector cables 204-208, and switch system 106, which includes switch system demultiplexers 210-214, switch system vertices 244-252, and switch system demultiplexer to switch system vertex connector cables 216-243.

In some approaches, power generator 1 118 is connected to switch system demultiplexer 210 within switch system 106 via power generator to switch system connector cable 124. Switch system demultiplexer 210 is connected to: switch system vertex 244 via switch system demultiplexer to switch system vertex connector cable 216, switch system vertex 246 via switch system demultiplexer to switch system vertex connector cable 218, switch system vertex 248 via switch system demultiplexer to switch system vertex connector cable 220, switch system vertex 250 via switch system demultiplexer to switch system vertex connector cable 222, and switch system vertex 252 via switch system demultiplexer to switch system vertex connector cable 224.

In some embodiments, power generator 2 120 is connected to switch system demultiplexer 212 within switch system 106 via power generator to switch system connector cable 126. Switch system demultiplexer 212 is connected to: switch system vertex 244 via switch system demultiplexer to switch system vertex connector cable 226, switch system vertex 246 via switch system demultiplexer to switch system vertex connector cable 228, switch system vertex 248 via switch system demultiplexer to switch system vertex connector cable 230, switch system vertex 250 via switch system demultiplexer to switch system vertex connector cable 232, and switch system vertex 252 via switch system demultiplexer to switch system vertex connector cable 234.

In some embodiments, power generator 3 122 is connected to switch system demultiplexer 214 within switch system 106 via power generator to switch system connector cable 128. Switch system demultiplexer 214 is connected to: switch system vertex 244 via switch system demultiplexer to switch system vertex connector cable 236, switch system vertex 246 via switch system demultiplexer to switch system vertex connector cable 238, switch system vertex 248 via switch system demultiplexer to switch system vertex connector cable 240, switch system vertex 250 via switch system demultiplexer to switch system vertex connector cable 242, and switch system vertex 252 via switch system demultiplexer to switch system vertex connector cable 243.

In some embodiments, switch system vertex 244 is connected to charging cable 108, switch system vertex 246 is connected to charging cable 110, switch system vertex 248 is connected to charging cable 112, switch system vertex 250 is connected to charging cable 114, and switch system vertex 252 is connected to charging cable 116.

In some embodiments, such aspects of system 200 allow power generators 118-122 to switch the flow of power amongst the charging cables 108-116 through switch system demultiplexers 210-214. In some embodiments, each of power generators 118-122 is connected to each of charging cables 108-116, and thus is able to provide power through any one of charging cables 108-116, depending on how charging station CPU 107 directs the flow of power.

In one example, charging station CPU 107 selects a vehicle connected to charging cable 108 to be in the subset of vehicles to be charged. In this example, charging station CPU 107 directs power to flow from power generator 1 118 through power generator to switch system connector cable 124 to switch system demultiplexer 210. In this embodiment, power will then flow from switch system demultiplexer 210 through switch system demultiplexer to switch system vertex connector cable 216 to switch system vertex 244. In this embodiment, power will then flow from switch system vertex 244 through charging cable 108 to the connected vehicle.

In one example, charging station CPU 107 removes the vehicle connected to charging cable 108 from the subset of vehicles to be charged, and chooses the vehicle connected to charging cable 116 to be in the subset of vehicles to be charged. In this example, charging station CPU 107 then redirects power flow from power generator 1 118 to flow from switch system demultiplexer 210 through switch system demultiplexer to switch system vertex connector cable 224 to switch system vertex 252, then finally through charging cable 116 to the vehicle connected to charging cable 116 (shutting off the power flow from switch system demultiplexer 210 through switch system demultiplexer to switch system vertex connector cable 216 to switch system vertex 244, so no more power flows through charging cable 108).

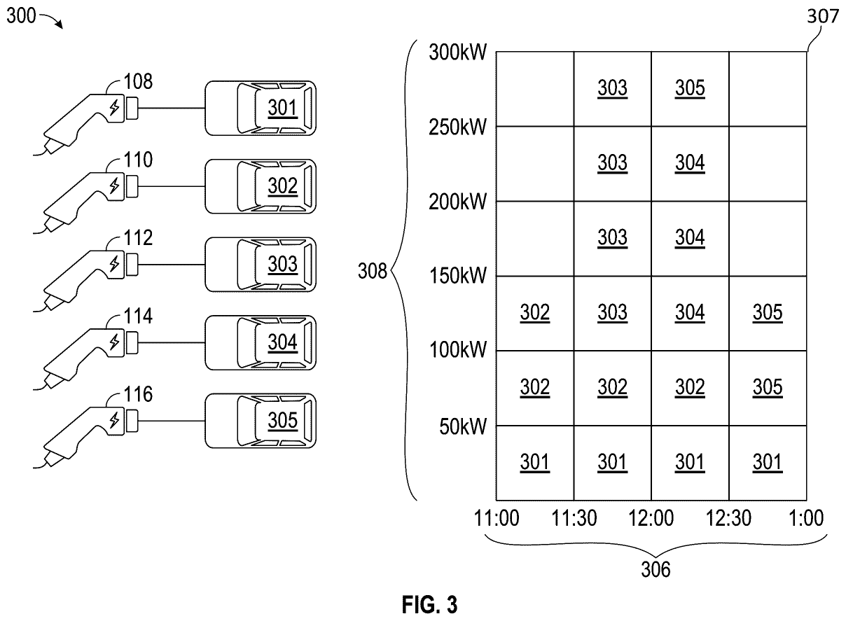

FIG. 3 shows an illustrative example of resource allocation of a 300 kW charging station, e.g., electric vehicle charging station 134 of FIG. 1, to five vehicles, in accordance with some embodiments of the present disclosure. In some embodiments, system 300 includes charging cables 108-116, vehicles 301-305, and charge power allocation schedule 307, which has times of the day in 30-minute increments starting at 11:00 AM and ending at 1:00 PM on the horizontal axis 306, and power in 50 kW increments starting at 0 kW and ending at 300 kW on the vertical axis 308.

In this example, charge power allocation schedule 307 shows that electric vehicle charging station 134 charges vehicle 301 with 50 kW of power from 11:00 AM to 1:00 PM. In this example, charge power allocation schedule 307 shows that electric vehicle charging station 134 charges vehicle 302 with 100 KW of power from 11:00 AM to 11:30 AM, and then 100 KW of power from 11:30 AM to 12:30 PM, and then 0 KW of power from 12:30 PM to 1:00 PM. In this example, charge power allocation schedule 307 shows that electric vehicle charging station 134 charges vehicle 303 with 0 KW of power from 11:00 AM to 11:30 AM, 200 kW of power from 11:30 AM to 12:00 PM, and 0 kW of power from 12:00 PM to 1:00 PM. In this example, charge power allocation schedule 307 shows that electric vehicle charging station 134 charges vehicle 304 with 0 kW of power from 11:00 AM to 12:00 PM, 150 KW of power from 12:00 PM to 12:30 PM, and 0 kW of power from 12:30 PM to 1:00 PM. In this example, charge power allocation schedule 307 shows that electric vehicle charging station 134 charges vehicle 305 with 0 KW of power from 11:00 AM to 12:00 PM, 50 KW of power from 12:00 PM to 12:30 PM, and 100 KW of power from 12:30 PM to 1:00 PM.

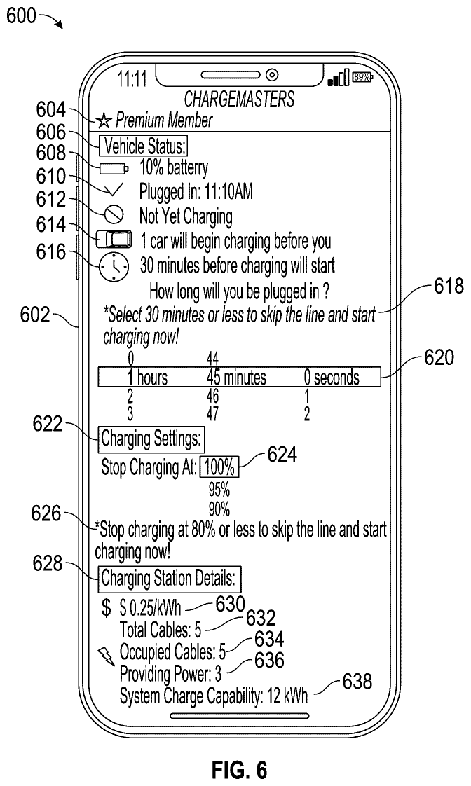

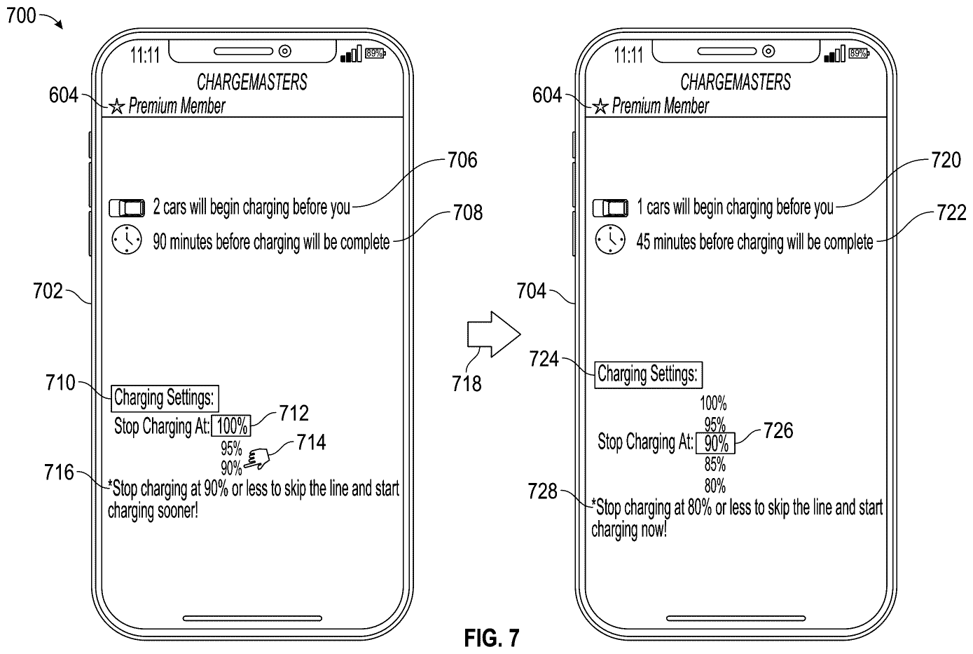

In some embodiments, such aspects of system 300 ensure that vehicle 301 has a total of 200 kW of charge, vehicle 302 has a total of 200 kW of charge, vehicle 303 has a total of 200 kW of charge, vehicle 304 has a total of 150 KW of charge, and vehicle 305 has a total of 150 kW of charge after two hours of being connected to electric vehicle charging station 134. In some embodiments, charge power allocation schedule 307 is determined based on at least one of the order of connection of vehicles to charging cables, charge level of each vehicle, vehicle charging user account status, price paid by vehicle charging user account for charging, time specified by the vehicle charging user account that the vehicle will be connected to a charging cable, number of charging cables currently providing power to vehicles, and/or charging capability of the system, as described further below with reference to FIGS. 6 and 7.

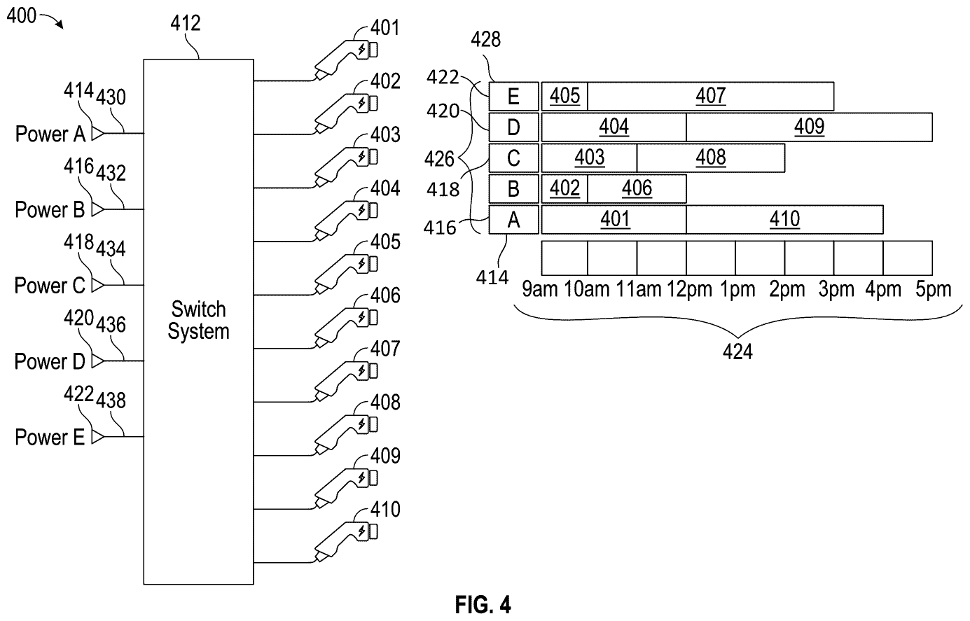

FIG. 4 shows an illustrative example of time-sharing chargers at an electric vehicle charging station, e.g., electric vehicle charging station 134 of FIG. 1, dynamically switching resources, in accordance with some embodiments of the present disclosure. In some embodiments, system 400 includes charging cables 401-410, switch system 412, power generators 414-422, power generator to switch system connector cables 430-438, and power generator to charging cable assignment schedule 428, which has times of the day in one-hour increments starting at 9:00 am and ending at 5:00 pm on the horizontal axis 424, and power generator buckets representing power generators 414-422 on the vertical axis 426.

In this example, power generator to charging cable assignment schedule 428 shows that electric vehicle charging station 134 sends power from power generator A 414 to charging cable 401 from 9:00am to 12:00 pm and charging cable 410 from 12:00 pm to 4:00 pm. In this example, power generator to charging cable assignment schedule 428 shows that electric vehicle charging station 134 sends power from power generator B 416 to charging cable 402 from 9:00 am to 10:00 am and charging cable 406 from 10:00 am to 12:00 pm. In this example, power generator to charging cable assignment schedule 428 shows that electric vehicle charging station 134 sends power from power generator C 418 to charging cable 403 from 9:00 am to 11:00 am and charging cable 408 from 11:00 am to 2:00 pm. In this example, power generator to charging cable assignment schedule 428 shows that electric vehicle charging station 134 sends power from power generator D 420 to charging cable 404 from 9:00 am to 12:00 pm and to charging cable 409 from 12:00 pm to 5:00 pm. In this example, power generator to charging cable assignment schedule 428 shows that electric vehicle charging station 134 sends power from power generator E 422 to charging cable 405 from 9:00 am to 10:00 am and charging cable 407 from 10:00 am to 3:00 pm.

In some embodiments, power generator to charging cable assignment schedule 428 is determined based on at least one of the order of connection of vehicles to charging cables, charge level of each vehicle, vehicle charging user account status, price paid by vehicle charging user account for charging, time specified by the vehicle charging user account that the vehicle will be connected to a charging cable, number of charging cables currently providing power to vehicles, and/or charging capability of the system, as described further below with reference to FIGS. 6 and 7.

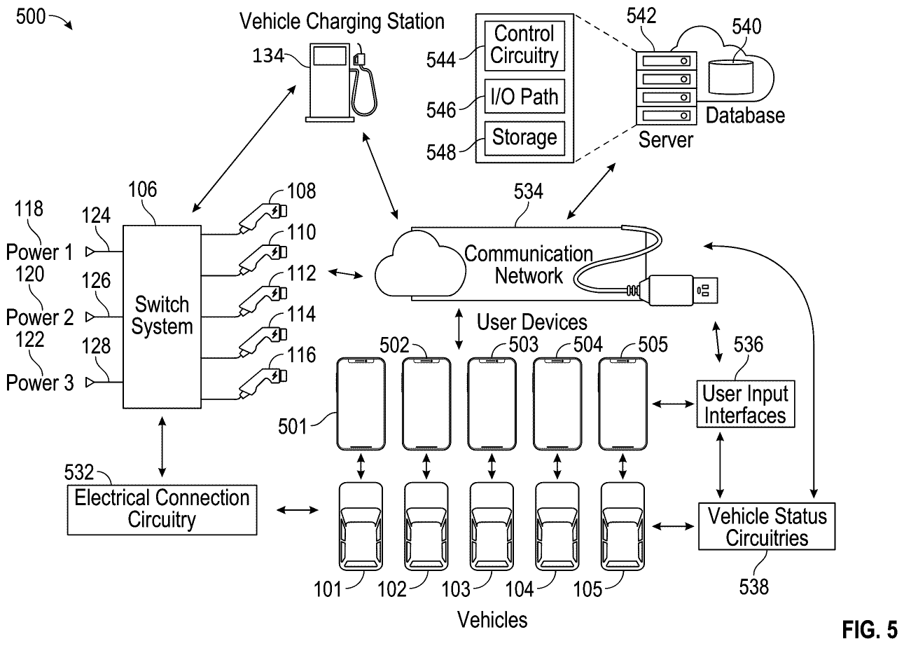

FIG. 5 shows illustrative devices, systems, servers, and related hardware for improving efficiency of electric vehicle charging stations, in accordance with some embodiments of the present disclosure. As shown in FIG. 5, electric vehicle charging station 134 of FIG. 1 (including power generators 118-122 of FIG. 1, power generator to switch system connector cables 124-128, switch system 106, and charging cables 108-116), user devices 501-505, and vehicles 101-105 may be coupled to communication network 534. Communication network 534 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 534) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with electric vehicle charging station 134, user devices 501-505, and vehicles 101-105 may be provided by one or more of these communications paths but are shown as a single path in FIG. 5 to avoid overcomplicating the drawing.

Although communications paths are not drawn between electric vehicle charging station 134 and user devices 501-505, or between vehicles 101-105 and electric vehicle charging station 134, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. Electric vehicle charging station 134, user devices 501-505, and vehicles 101-105 may also communicate with each other directly through an indirect path via communication network 534. In some embodiments, each user device of user devices 501-505 is communicatively coupled with a particular vehicle of vehicles 101-105, e.g., user device 501 is communicatively coupled with vehicle 101. In some embodiments, vehicles 101-105 include vehicle status circuitries 538, which may provide vehicle status data to user devices 501-505. In some embodiments, user devices 501-505 include user input interfaces 536, as described further below with reference to FIGS. 6 and 7. In some embodiments, vehicles 101-105 are communicatively coupled to electric vehicle charging station 134 via electrical connection circuitry 532, as vehicles 101-105 are electrically connected to electric vehicle charging station 134 via charging cables 108-116.

System 500 may comprise one or more servers 542 and/or one or more computing devices. In some embodiments, the charging application may be executed at one or more of control circuitry 544 of server 542 (and/or control circuitry of electric vehicle charging station 134 and user devices 501-505 and/or control circuitry of one or more edge computing devices). In some embodiments, server 542 may be configured to be in communication (e.g., over communication network 534) with one or more social network services. In some embodiments, charging station CPU 107 of FIG. 1 is part of server 542.

In some embodiments, server 542 includes control circuitry 544 and storage 548 (e.g., RAM, ROM, hard disk, removable disk, etc.). Storage 548 may store one or more databases, e.g., database 540. Server 542 may also include an I/O path 546. I/O path 546 may provide vehicle charging data, device information, or other data, over a local area network (LAN) or wide area network (WAN), and/or other content and data to control circuitry 544, which may include processing circuitry, and storage 548. Control circuitry 544 may be used to send and receive commands, requests, and other suitable data using I/O path 546, which may comprise I/O circuitry. I/O path 546 may connect control circuitry 544 (and specifically control circuitry) to one or more communications paths.

Control circuitry 544 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 544 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 544 executes instructions for a charging application stored in memory (e.g., the storage 548). Memory may be an electronic storage device provided as storage 548 that is part of control circuitry 544.

FIG. 6 shows an illustrative example of a user interface system for improving efficiency of electric vehicle charging stations, in accordance with some embodiments of the present disclosure. In some embodiments, system 600 is a user device of user devices 501-505 of FIG. 5, e.g., a smartphone. In some embodiments, system 600 includes user input interface 602, and in some examples, user input interface 602 is a user input interface of user input interfaces 536 of FIG. 5, e.g., a smartphone application. In some embodiments, system 600 is associated with a particular vehicle, e.g., one of vehicles 101-105 of FIG. 5, for example, because the driver of the vehicle is the user of system 600, e.g., the smartphone. In some embodiments, user input interface 602 is associated with a user account created by a driver of the particular vehicle associated with system 600.

In some embodiments, user input interface 602 has membership indicator 604. In some embodiments, membership indicator 604 indicates that the user account pays for a premium charging membership. In some embodiments, user accounts with premium memberships have charging priority over user accounts with regular memberships.

In some embodiments, the charging station, e.g., electric vehicle charging station 134 of FIG. 1, transmits data from, e.g., charging station CPU 107 of FIG. 1, to system 600, e.g., a smartphone associated with a vehicle charging user account of a vehicle electrically connected to a charging cable, e.g., one of charging cables 108-116 of FIG. 1, of electric vehicle charging station 134. In some embodiments, this data transmission is done over a communication network, as described further above with reference to FIG. 5. In some embodiments, the data transmitted from the charging station to system 600 was first transmitted to the charging station by the vehicle associated with system 600 that is plugged into the charging station. In some approaches, the vehicle associated with system 600 transmits data to the charging station over a communication network, as described further above with reference to FIG. 5. In some approaches, system 600 transmits data to the charging station. In some approaches, this data transmission is also done over a communication network, as described further above with reference to FIG. 5. In some embodiments, user input interface 602 has vehicle status indicators 606 (including battery indicator 608, plug-in confirmation indicator 610, charging confirmation indicator 612, charge queue indicator 614, charge wait time indicator 616), time-based skip-the-line instructions 618, plug-in time selector 620, charging settings 622 (including stop charge battery level selector 624 and battery level-based skip-the-line instructions 626), and charging station details 628 (including cost indicator 630, total number of cables indicator 632, number of occupied cables indicator 634, number of cables providing power indicator 636, and system charge capability indicator 638). In some embodiments, vehicle status indicators 606 (including indicators 608-616) and charging station details 628 (including indicators 630-638) are populated by data from the data transmissions from a charging station CPU, e.g., charging station CPU 107 of FIG. 1, to system 600. In some approaches, the user selections of plug-in time selector 620 and stop charge battery level selector 624 are transmitted from system 600 to the charging station. In some embodiments, the charging station alters the flow of power from power generators to charging cables based on transmissions of the user selections of plug-in time selector 620 and stop charge battery level selector 624, as described further above with reference to FIG. 2.

In some embodiments, battery indicator 608 is an indication of the current battery level of the vehicle associated with system 600, e.g., a graphic of a battery and the text “10% battery.” In some embodiments, plug-in confirmation indicator 610 is a confirmation that the vehicle associated with system 600 has been plugged into the charging station, e.g., a checkmark and the text “Plugged In,” as well as a timestamp of when the vehicle associated with system 600 was plugged into the charging station, e.g., 11:10 am. In some embodiments, charging confirmation indicator 612 is a confirmation that the vehicle associated with system 600 is not yet charging, e.g., a not yet charging symbol and the text “Not Yet Charging.” In some embodiments, charge queue indicator 614 is how many vehicles will begin charging before the vehicle associated with system 600, e.g., a graphic of a vehicle and the text “1 car will begin charging before you.” In some embodiments, charge wait time indicator 616 is how many minutes it will take before the vehicle associated with system 600 will begin to charge, e.g., a graphic of a clock and the text “30 minutes before charging will start.”

In some embodiments, time-based skip-the-line instructions 618 are instructions of what plug-in time selector 620 must be set to in order for the vehicle associated with system 600 to skip the line (for example, to bypass the cars indicated in charge queue indicator 614 that will begin charging before the vehicle associated with system 600), e.g., the text “Select 30 minutes or less to skip the line and start charging now!” In some embodiments, plug-in time selector 620 is a scrollable grid of numbers allowing for a user selection of a number of hours, minutes, and seconds that the vehicle associated with system 600 will be plugged into the charging station, e.g., 1 hour, 45 minutes, and 0 seconds. In one approach, a user selection of, e.g., 30 minutes or less within plug-in time selector 620 causes system 600 to transmit the data to the charging station to redirect the flow of power (as described further above with reference to FIG. 2) to the charging cable connected to the vehicle associated with system 600 to begin charging the vehicle associated with system 600 right away.

In some approaches, battery level-based skip-the-line instructions 626 are instructions of what stop charge battery level selector 624 must be set to in order for the vehicle associated with system 600 to skip the line (for example, to bypass the cars indicated in charge queue indicator 614 that will begin charging before the vehicle associated with system 600), e.g., the text “Stop charging at 80% or less to skip the line and start charging now!” In some embodiments, stop charge battery level selector 624 is a scrollable grid of numbers allowing for a user selection of a battery level for the vehicle associated with system 600 to stop charging at, e.g., 100%. In one approach, a user selection of, e.g., 80% or less within stop charge battery level selector 624 will cause system 600 to transmit the data to the charging station to redirect the flow of power (as described further above with reference to FIG. 2) to the charging cable connected to the vehicle associated with system 600 to begin charging the vehicle associated with system 600 right away, as described further below with reference to FIG. 7.

In some approaches, cost indicator 630 is an indication of the cost in cents per kilowatt/hour to charge at the charging station that the vehicle associated with system 600 is electrically connected to, e.g., the text “$0.25/kWh.” In one approach, the total number of cables indicator 632 is an indication of the total number of cables there are at the charging station that the vehicle associated with system 600 is electrically connected to, e.g., the text “Total Cables: 5.” In one approach, the number of occupied cables indicator 634 is an indication of the number of occupied cables there are at the charging station that the vehicle associated with system 600 is electrically connected to, e.g., the text “Occupied Cables: 5.” In one approach, the number of cables providing power indicator 636 is an indication of the number of cables currently providing power to a vehicle at the charging station that the vehicle associated with system 600 is electrically connected to, e.g., the text “Providing Power: 3.” In one approach, system charge capability indicator 638 is an indication of the total charge capability of the charging station that the vehicle associated with system 600 is electrically connected to, i.e., the amount of power the charging station can provide at one time, e.g., the text “12 kWh.”

FIG. 7 shows an illustrative example of a user interface system for improving efficiency of electric vehicle charging stations, in accordance with some embodiments of the present disclosure. In some approaches, system 700 is two different views of a user device (e.g., system 600) of user devices 501-505 of FIG. 5, e.g., a smartphone. In some embodiments, system 700 includes a first view of a user input interface 702 and second view of a user input interface 704, and in some examples, the views of the user input interface 702-704 are views of a user input interface of user input interfaces 536 of FIG. 5, e.g., a smartphone application. In some embodiments, system 700 is associated with a particular vehicle, e.g., one of vehicles 101-105 of FIG. 5, for example, because the driver of the vehicle is the user of system 700, e.g., the smartphone. In some embodiments, the views of the user input interface 702-704 are associated with a user account created by a driver of the particular vehicle associated with system 700.

In some embodiments, the views of the user input interface 702-704 have membership indicator 604, as described further above with reference to FIG. 6. In some embodiments, first view of a user input interface 702 includes first view charge queue indicator 706, first view charge completion time indicator 708, and first view charging settings 710 (including first view battery level-based skip-the-line instructions 716 and first view stop charge battery level selector 712). In some embodiments, second view of a user input interface 704 includes second view charge queue indicator 720, second view charge completion time indicator 722, and second view charging settings 724 (including second view battery level-based skip-the-line instructions 728 and second view stop charge battery level selector 712).

In some embodiments, first view charge queue indicator 706 and second view charge queue indicator 720 are indicators of how many vehicles will begin charging before the vehicle associated with system 700. In some embodiments, first view charge completion time indicator 708 and second view charge completion time indicator 722 are indicators of how many minutes it will take before the vehicle associated with system 700 will be finished charging.

In some examples, first view charge queue indicator 706 indicates that two cars will begin charging before the vehicle associated with system 700, first view charge completion time indicator 708 indicates that charging will be complete in 90 minutes, first view stop charge battery level selector 712 displays 100% as the selected battery level at which to stop charging, and first view battery level-based skip-the-line instructions 716 have the text “Stop charging at 90% or less to skip the line and start charging sooner!” In one example, first view of a user input interface 702 receives a user selection 714 to change first view stop charge battery level selector 712 to instead stop charging at 90%, and in response, first view of a user input interface 702 becomes second view of a user input interface 704. In this example, second view charge queue indicator 720 indicates that one vehicle will begin charging before the vehicle associated with system 700, second view charge completion time indicator 722 indicates that charging will be complete in 45 minutes, second view battery level-based skip-the-line instructions 728 have the text “Stop charging at 80% or less to skip the line and start charging now!” and second view stop charge battery level selector 712 displays 90% as the selected battery level at which to stop charging.

In such embodiments, incentivizing to stop charging at a battery percentage level lower than 100%, e.g., 80%, promotes battery health and longevity of vehicle batteries. In such embodiments, stopping charging at a battery percentage level lower than 100%, e.g., 80%, also allows for more efficient use of the charging station. For example, a vehicle with an 80 kW battery capacity being charged by a level 2 charger with 20 KW capacity will take four hours to fully charge from 0 to 100%. However, in this example, if the vehicle with the 80 kW battery capacity is set to stop charging at 80% battery level, the vehicle will take three hours and twelve minutes to finish charging. In this example, another vehicle could start charging 48 minutes earlier than it would if the original vehicle was set to stop charging at 100% battery level, increasing the overall efficiency of the charging station.

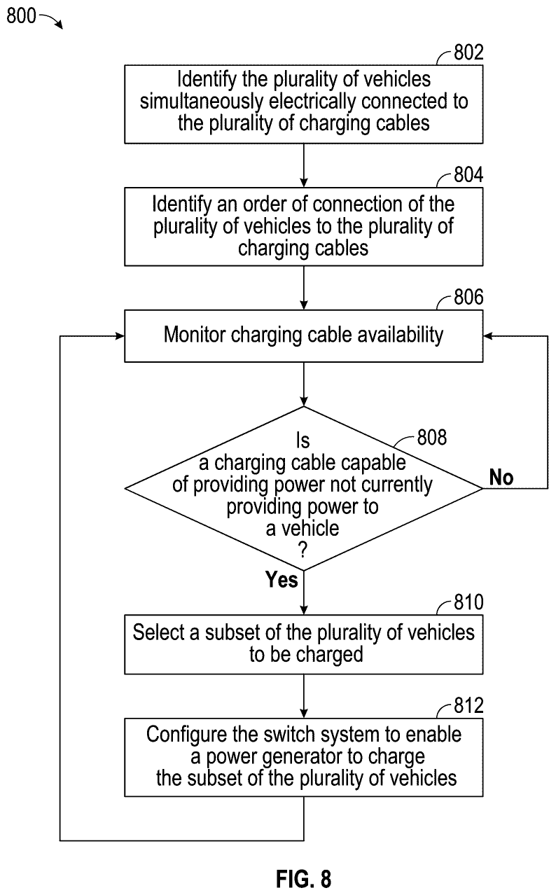

FIG. 8 shows a flowchart of an illustrative process for improving efficiency of electric vehicle charging stations, in accordance with some embodiments of the present disclosure. In various embodiments, the individual steps of process 800 may be implemented by charging station CPU 107 of FIG. 1, or any other part of server 542 of FIG. 5. For example, non-transitory memories of one or more components of charging station CPU 107 of FIG. 1, or any of the servers or devices of FIG. 5, may store instructions that, when executed by charging station CPU 107 of FIG. 1, or the server and devices of FIG. 5, cause execution of the steps of process 800. In some embodiments, the process steps in process 800 may be performed in an alternative order to the flow depicted in FIG. 8.

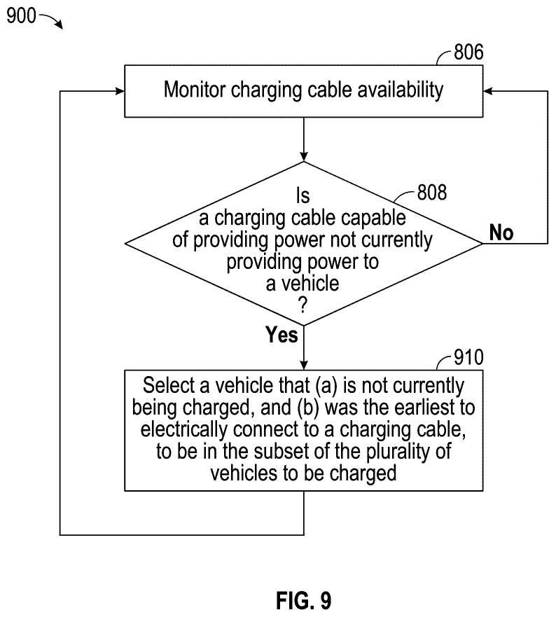

In some approaches, at 802, a charging station CPU, e.g., charging station CPU 107 of FIG. 1, identifies the plurality of vehicles, e.g., five vehicles, e.g., vehicles 101-105 of FIG. 1, simultaneously electrically connected to the plurality of charging cables, e.g., five cables, e.g., charging cables 108-116 of FIG. 1, at a vehicle charging station, e.g., electric vehicle charging station 134 of FIG. 1. In some approaches, at 804, the charging station CPU identifies an order of connection of the plurality of vehicles to the plurality of charging cables, e.g., vehicle 101 was the earliest to electrically connect, vehicle 102 was next, etc. In some approaches, at 806, the charging station CPU monitors charging cable availability. In some embodiments, at 808, the charging station CPU determines whether a charging cable capable of providing power is not currently providing power to a vehicle. In some embodiments, the number of charging cables capable of providing power to a vehicle, e.g., three capable charging cables, at the vehicle charging station is equal to the number of power generators, e.g., three power generators, e.g., power generators 118-122 of FIG. 1, at the vehicle charging station. In some embodiments, if the charging station CPU determines that there are no charging cables capable of providing power that are not currently providing power to a vehicle, process 800 returns to 806, and the charging station CPU continues to monitor charging cable availability. In some embodiments, if the charging station CPU determines that there is a charging cable capable of providing power that is not currently providing power to a vehicle, process 800 proceeds to 810. In some embodiments, at 810, the charging station CPU selects a subset of the plurality of vehicles to be charged, e.g., three vehicles, e.g., vehicles 101-103 of FIG. 1, as described further below with reference to FIG. 9. In some embodiments, at 812, the charging station CPU configures the switch system, e.g., switch system 106 of FIG. 1, to enable power generators, e.g., power generators 118-122 of FIG. 1, to charge the subset of the plurality of vehicles, as described further above with reference to FIG. 2.

FIG. 9 shows a flowchart of an illustrative process for improving efficiency of electric vehicle charging stations, in accordance with some embodiments of the present disclosure. In various embodiments, the individual steps of process 900 may be implemented by charging station CPU 107 of FIG. 1, or any other part of server 542 of FIG. 5. For example, non-transitory memories of one or more components of charging station CPU 107 of FIG. 1, or any of the servers or devices of FIG. 5, may store instructions that, when executed by charging station CPU 107 of FIG. 1, or the server and devices of FIG. 5, cause execution of the steps of process 900. In some embodiments, the process steps in process 800 may be performed in an alternative order to the flow depicted in FIG. 9.

In some approaches, at 806, the charging station CPU monitors charging cable availability. In some embodiments, at 808, the charging station CPU determines whether a charging cable capable of providing power is not currently providing power to a vehicle, as described further above with reference to FIG. 8. In some embodiments, if the charging station CPU determines that there are no charging cables capable of providing power that are not currently providing power to a vehicle, process 900 returns to 806, and the charging station CPU continues to monitor charging cable availability. In some embodiments, if the charging station CPU determines that there is a charging cable capable of providing power that is not currently providing power to a vehicle, process 900 proceeds to 910. In some embodiments, at 910, the charging station CPU selects a vehicle that (a) is not currently being charged, and (b) was the earliest to electrically connect to a charging cable to be in the subset of the plurality of vehicles to be charged. In one example, a charging station, e.g., electric vehicle charging station 134 of FIG. 1, has three power generators, e.g., power generators 118-122 of FIG. 1, and is currently charging three vehicles, e.g., vehicles 101-103 of FIG. 1. In this example, vehicle 101 finishes charging, and the charging station CPU selects vehicle 104 to be in the subset of the plurality of vehicles to be charged because (a) it is not currently being charged, and (b) it was electrically connected to a charging cable prior to vehicle 105, the only other vehicle of vehicles 101-105 that has not yet been charged.

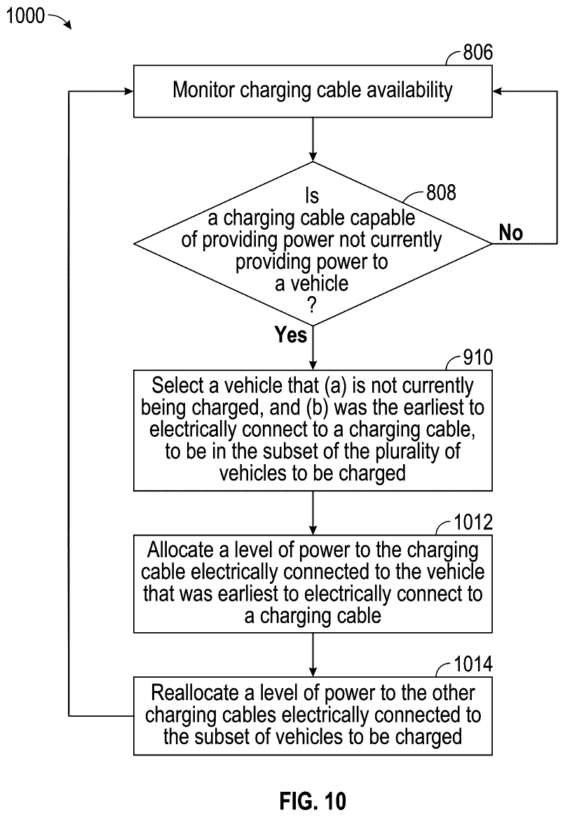

FIG. 10 shows a flowchart of an illustrative process for improving efficiency of electric vehicle charging stations, in accordance with some embodiments of the present disclosure. In various embodiments, the individual steps of process 1000 may be implemented by charging station CPU 107 of FIG. 1, or any other part of server 542 of FIG. 5. For example, non-transitory memories of one or more components of charging station CPU 107 of FIG. 1, or any of the servers or devices of FIG. 5, may store instructions that, when executed by charging station CPU 107 of FIG. 1, or the server and devices of FIG. 5, cause execution of the steps of process 1000. In some embodiments, the process steps in process 1000 may be performed in an alternative order to the flow depicted in FIG. 10.

In some approaches, at 806, the charging station CPU monitors charging cable availability. In some embodiments, at 808, the charging station CPU determines whether a charging cable capable of providing power is not currently providing power to a vehicle, as described further above with reference to FIG. 8. In some embodiments, if the charging station CPU determines that there are no charging cables capable of providing power that are not currently providing power to a vehicle, process 1000 returns to 806, and the charging station CPU continues to monitor charging cable availability. In some embodiments, if the charging station CPU determines that there is a charging cable capable of providing power that is not currently providing power to a vehicle, process 1000 proceeds to 910. In some embodiments, at 910, the charging station CPU selects a vehicle that (a) is not currently being charged, and (b) was the earliest to electrically connect to a charging cable to be in the subset of the plurality of vehicles to be charged, as described further above with reference to FIG. 9. In some embodiments, process 1000 then proceeds to 1012. In some approaches, at 1012, the charging station CPU allocates a level of power to a charging cable electrically connected to the vehicle that was the earliest to electrically connect to the plurality of charging cables. In some examples, the level of power is less than or equal to the amount of power that power generators, e.g., power generators 118-122 of FIG. 1, are able to generate. In some embodiments, the charging station CPU may determine the level of power to allocate to the charging cable based on the charging station CPU receiving a data transmission of a user interface input on a user input interface, e.g., user input interface 602 of FIG. 6 or the user input interface depicted in system 700, as described further above with reference to FIGS. 6 and 7. For example, if the charging station CPU receives a data transmission of a user interface input indicating that a vehicle will be plugged in for a short amount of time, e.g., 30 minutes, the charging station CPU may allocate more power to the charging cable that vehicle is plugged into. In some embodiments, data transmissions of user interface inputs on a user input interface may be used to determine a charge power allocation schedule, e.g., charge power allocation schedule 307 of FIG. 3, as described further above with reference to FIG. 3. In this approach, the charging station CPU uses the data transmissions of many user interface inputs from many devices, e.g., user devices 501-505 of FIG. 5, to determine a schedule of how to allocate power to different chargers throughout a day to ensure that every plugged-in vehicle is efficiently charged, as described further above with reference to FIG. 3.

In some embodiments, process 1000 then proceeds to 1014. In some approaches, at 1012, the charging station CPU reallocates a level of power to the other charging cables in the plurality of charging cables electrically connected to the subset of the plurality of vehicles to be charged. In some embodiments, the charging station CPU reallocates the level of power based on the level of power allocated to the charging cable electrically connected to the vehicle that was the earliest to electrically connect to the plurality of charging cables. In some embodiments, the total power allocated to the vehicles in the subset of the plurality of vehicles to be charged is less than or equal to the amount of power the at least one power generator is able to generate.

The foregoing is merely illustrative of the principles of this disclosure and its various embodiments. Various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations and modifications thereof, which are within the spirit of the following claims.

1. A system comprising:
at least one power generator;
a plurality of charging cables electrically connected to the at least one power generator by a switch system, wherein each respective charging cable of the plurality of charging cables is electrically connected to a respective vehicle of a plurality of vehicles, and wherein only a subset of the plurality of charging cables is capable of providing power simultaneously;
a control circuitry configured to:
identify the plurality of vehicles simultaneously electrically connected to the plurality of charging cables;
identify an order of connection of the plurality of vehicles to the plurality of charging cables;
based on the order of connection, select a subset of the plurality of vehicles to be charged, wherein a total number of vehicles in the subset of the plurality of vehicles to be charged is less than or equal to a number of charging cables in the subset of charging cables capable of providing power to the subset of the plurality of vehicles; and
configure the switch system to enable the at least one power generator to charge the subset of the plurality of vehicles.

2. The system of claim 1, wherein the control circuitry is further configured to:
configure the switch system such that the at least one power generator does not charge vehicles connected to at least one of the plurality of charging cables that are not in the subset of the plurality of vehicles to be charged.

3. The system of claim 1, wherein the control circuitry is further configured to:
configure the switch system such that the at least one power generator simultaneously charges all of the plurality of vehicles simultaneously electrically connected to the plurality of charging cables.

4. The system of claim 1, wherein the control circuitry is configured to select the subset of the plurality of vehicles to be charged by:
determining that one or more charging cables in the subset of the plurality of charging cables capable of providing power simultaneously is not currently providing power to a vehicle; and
selecting a vehicle of vehicles not currently being charged in the plurality of vehicles simultaneously electrically connected to the plurality of charging cables that was earliest to electrically connect to the plurality of charging cables to be in the subset of the plurality of vehicles to be charged.

5. The system of claim 4, wherein the control circuitry is further configured to:
in response to the selecting the vehicle that was earliest to electrically connect to the plurality of charging cables to be in the subset of the plurality of vehicles to be charged:
allocate a level of power to a charging cable electrically connected to the vehicle that was earliest to electrically connect to the plurality of charging cables, wherein the level of power is less than or equal to an amount of power the at least one power generator is able to generate; and
based on the level of power allocated to the charging cable electrically connected to the vehicle that was earliest to electrically connect to the plurality of charging cables, reallocate a level of power to the other charging cables in the plurality of charging cables electrically connected to the subset of the plurality of vehicles to be charged, wherein total power allocated to the vehicles in the subset of the plurality of vehicles to be charged is less than or equal to the amount of power the at least one power generator is able to generate.

6. The system of claim 1, further comprising:
input/output circuitry configured to:
receive, from a user device associated with a vehicle electrically connected to a charging cable of the plurality of charging cables, a user interface input indicating a period of time during which the vehicle is expected to be electrically connected to the charging cable; and
wherein the control circuitry is further configured to select the subset of the plurality of vehicles to be charged based on the user interface input indicating the period of time during which the vehicle is expected to be electrically connected to the charging cable.

7. The system of claim 1, wherein the control circuitry is further configured to select the subset of the plurality of vehicles to be charged based on at least one of: (a) charge level of each vehicle, (b) vehicle charging user account status, (c) price paid by vehicle charging user account for charging, (d) time specified by the vehicle charging user account that the vehicle will be connected to a charging cable, (e) number of charging cables currently providing power to vehicles, or (f) charging capability of the system.

8. The system of claim 1, wherein the control circuitry is further configured to select the subset of the plurality of vehicles to be charged based on charging settings of each vehicle of the plurality of vehicles, wherein the charging settings of each vehicle comprise a battery level at which to stop or slow charging, and wherein the control circuitry is further configured to:
stop or slow charging of a first vehicle when the first vehicle reaches the battery level at which to stop or slow charging specified in the charging settings of the first vehicle;
determine a second vehicle, wherein the second vehicle is a vehicle of vehicles not currently being charged in the plurality of vehicles simultaneously electrically connected to the plurality of charging cables that was earliest to electrically connect to the plurality of charging cables, to be in the subset of the plurality of vehicles to be charged.

9. The system of claim 1, further comprising:
input/output circuitry configured to:
transmit data to a user device associated with a vehicle charging user account of a vehicle electrically connected to a charging cable of the plurality of charging cables, and wherein the data comprises at least one of: (a) a confirmation that the vehicle is electrically connected to a charging cable of the plurality of charging cables, (b) the number of other vehicles that will be charged prior to the vehicle beginning charging, or (c) an estimate of how much time it will take for the vehicle to begin charging.

10. The system of claim 1, further comprising:
input/output circuitry configured to:
receive, from a user device associated with a vehicle charging user account of a vehicle electrically connected to a charging cable of the plurality of charging cables, a selection of a user interface option to modify charging settings of the vehicle to stop charging at less than a threshold percentage of battery level; and
wherein the control circuitry is further configured to select the vehicle with the charging setting to stop charging at less than the threshold percentage of battery level to be in the subset of the plurality of vehicles to be charged prior to selecting a vehicle that was earliest to electrically connect to the plurality of charging cables.

11. The system of claim 1, further comprising:
input/output circuitry configured to:
receive, from a user device associated with a vehicle charging user account of a vehicle electrically connected to a charging cable of the plurality of charging cables, an indication that the vehicle will be electrically connected to the plurality of charging cables for less than a threshold amount of time; and
wherein the control circuitry is further configured to select the vehicle to be in the subset of the plurality of vehicles to be charged prior to selecting a vehicle that was earliest to electrically connect to the plurality of charging cables.

12. The system of claim 1, further comprising:
input/output circuitry configured to:
receive, from a user device associated with a vehicle charging user account of a vehicle electrically connected to a charging cable of the plurality of charging cables, an indication of an amount of time that the vehicle will be electrically connected to the plurality of charging cables;
based on the indication, allocate a level of power to the charging cable that the vehicle is electrically connected to for the indicated amount of time; wherein the level of power is less than or equal to the amount of power the at least one power generator is able to generate; and
based on the level of power allocated to the charging cable electrically connected to the vehicle, reallocate the level of power to the other charging cables in the plurality of charging cables electrically connected to the subset of the plurality of vehicles to be charged, wherein the total power allocated to the vehicles in the subset of the plurality of vehicles to be charged is less than or equal to the amount of power the at least one power generator is able to generate.

13. The system of claim 1, wherein the control circuitry is further configured to allocate a level of power to each charging cable of the plurality of charging cables based on at least one of: (a) charge level of each vehicle, (b) vehicle charging user account status, (c) price paid by vehicle charging user account for charging, (d) time specified by the vehicle charging user account that the vehicle will be connected to a charging cable, (e) number of charging cables currently providing power to vehicles, or (f) charging capability of the system.

14. A method comprising:
identifying, via control circuitry of an electric vehicle charging station, a plurality of vehicles simultaneously electrically connected to a plurality of charging cables, wherein the plurality of charging cables are electrically connected to at least one power generator by a switch system, wherein each respective charging cable of the plurality of charging cables is electrically connected to a respective vehicle of the plurality of vehicles, and wherein only a subset of the plurality of charging cables is capable of providing power simultaneously;
identifying, via the control circuitry, an order of connection of the plurality of vehicles to the plurality of charging cables;
based on the order of connection, selecting, via the control circuitry, a subset of the plurality of vehicles to be charged, wherein a total number of vehicles in the subset of the plurality of vehicles to be charged is less than or equal to a number of charging cables in the subset of charging cables capable of providing power to the subset of the plurality of vehicles; and
configuring the switch system, via the control circuitry, to enable the at least one power generator to charge the subset of the plurality of vehicles.

15. The method of claim 14, further comprising:
configuring the switch system, via the control circuitry, such that the at least one power generator does not charge vehicles connected to at least one of the plurality of charging cables that are not in the subset of the plurality of vehicles to be charged.

16. The method of claim 14, further comprising:
configuring the switch system, via the control circuitry, such that the at least one power generator simultaneously charges all of the plurality of vehicles simultaneously electrically connected to the plurality of charging cables.

17. The method of claim 14, wherein the selecting the subset of the plurality of vehicles to be charged comprises:
determining, via the control circuitry, that one or more charging cables in the subset of the plurality of charging cables capable of providing power simultaneously is not currently providing power to a vehicle; and
selecting, via the control circuitry, a vehicle of vehicles not currently being charged in the plurality of vehicles simultaneously electrically connected to the plurality of charging cables that was earliest to electrically connect to the plurality of charging cables to be in the subset of the plurality of vehicles to be charged.

18. The method of claim 17, further comprising:
in response to the selecting, via the control circuitry, the vehicle that was earliest to electrically connect to the plurality of charging cables to be in the subset of the plurality of vehicles to be charged:
allocating, via the control circuitry, a level of power to a charging cable electrically connected to the vehicle that was earliest to electrically connect to the plurality of charging cables, wherein the level of power is less than or equal to an amount of power the at least one power generator is able to generate; and
based on the level of power allocated to the charging cable electrically connected to the vehicle that was earliest to electrically connect to the plurality of charging cables, reallocating, via the control circuitry, a level of power to the other charging cables in the plurality of charging cables electrically connected to the subset of the plurality of vehicles to be charged, wherein total power allocated to the vehicles in the subset of the plurality of vehicles to be charged is less than or equal to the amount of power the at least one power generator is able to generate.

19. The method of claim 14, further comprising:
receiving, via input/output circuitry, from a user device associated with a vehicle electrically connected to a charging cable of the plurality of charging cables, a user interface input indicating a period of time during which the vehicle is expected to be electrically connected to the charging cable; and
selecting, via the control circuitry, the subset of the plurality of vehicles to be charged based on the user interface input indicating the period of time during which the vehicle is expected to be electrically connected to the charging cable.

20-39. (canceled)

40. A system comprising:
means for identifying, via control circuitry of an electric vehicle charging station, a plurality of vehicles simultaneously electrically connected to a plurality of charging cables, wherein the plurality of charging cables are electrically connected to at least one power generator by a switch system, wherein each respective charging cable of the plurality of charging cables is electrically connected to a respective vehicle of the plurality of vehicles, and wherein only a subset of the plurality of charging cables is capable of providing power simultaneously;
means for identifying, via the control circuitry, an order of connection of the plurality of vehicles to the plurality of charging cables;
means for selecting, via the control circuitry, based on the order of connection, a subset of the plurality of vehicles to be charged, wherein a total number of vehicles in the subset of the plurality of vehicles to be charged is less than or equal to a number of charging cables in the subset of charging cables capable of providing power to the subset of the plurality of vehicles; and
means for configuring the switch system, via the control circuitry, to enable the at least one power generator to charge the subset of the plurality of vehicles.

41-65. (canceled)
